(19) United States
(12) Patent Application Publication
(10) Pub. No.: US 2022/0230514 A1
(43) Pub. Date: Jul. 21, 2022

(54) PRODUCT RECOGNITION APPARATUS, SYSTEM, AND METHOD

(71) Applicant: NEC Platforms, Ltd., Kawasaki-shi (JP)

(72) Inventor: Tomoya NAKAGAWASAI, Kanagawa (JP)

(73) Assignee: NEC Platforms, Ltd., Kawasaki-shi (JP)

(21) Appl. No.: 17/572,822

(22) Filed: Jan. 11, 2022

(30) Foreign Application Priority Data
Jan. 20, 2021 (JP) 2021-007009

(51) Int. Cl. G07G 1/00; G06K 9/62

(52) U.S. Cl. CPC G07G 1/0036; G06K 9/6215

(57) ABSTRACT

A product recognition system which displays candidates of product names for each captured image of each product in a manner which is compact and allows the candidates to be recognized at a glance. A product recognition apparatus includes an acquisition unit that acquires an image of a product to be purchased and a calculation unit that calculates a degree of similarity between the image of the product to be purchased and an image of a product stored in association with a product name in advance, a specifying unit that specifies a candidate of the product name corresponding to the product to be purchased based on the calculated degree of similarity, and a generation unit that generates a composite image obtained by superposing the name of the specified candidate of the product name on the image of the product to be purchased.

### INCORPORATION BY REFERENCE

This application is based upon and claims the benefit of priority from Japanese patent application No. 2021-007009, filed on Jan. 20, 2021, the disclosure of which is incorporated herein in its entirety by reference.

### TECHNICAL FIELD

The present disclosure relates to a product recognition apparatus, system, and method.

### BACKGROUND ART

Recently, a POS (Point Of Sales) terminal apparatus for performing settlement processing such as registration of a product and checking-out has become widespread. The POS terminal apparatus registers a product corresponding to an identifier input by reading a barcode attached to the product by means of a scanner as a product to be purchased by a customer. By printing the barcode on a package of the product or the like in advance, the burden on a store clerk who performs settlement processing can be reduced.

However, for example, it is extremely troublesome to attach a barcode to each product of, for example, a vegetable and fruit product, which requires time and cost. For this reason, a store clerk who performs settlement processing for vegetables and fruits and the like inputs a product code and a price using a keyboard. Therefore, a technique such as the technique disclosed in Japanese Unexamined Patent Application Publication No. 2014-160513 in which an image of a product is captured and an object in the image is recognized to thereby identify the product, and then the identified product is registered for sale is spreading.

### SUMMARY

In the technique disclosed in Japanese Unexamined Patent Application Publication No. 2014-160513, the captured image of the product is displayed separately from product name candidates, and thus the image of the product and the product name candidates are not displayed in a compact manner. When the captured image of the product and the product name candidates are displayed on, for example, a tablet terminal, the display of the image of the product and the product name candidates may become small, resulting in poor operability. For this reason, it is desirable that the captured images of the respective products be displayed in a more compact manner as to what kind of product names there are as candidates, and that the captured images be recognized at a glance.

An object of the present disclosure is to provide a product recognition apparatus, a product recognition system, and a product recognition method for solving such a problem.

In an example aspect of the present disclosure, a product recognition apparatus according to the present disclosure includes: an acquisition unit configured to acquire an image of a product to be purchased; a calculation unit configured to calculate a degree of similarity between the image of the product to be purchased and an image of a product stored in association with a product name in advance; a specifying unit configured to specify a candidate of the product name corresponding to the product to be purchased based on the calculated degree of similarity; and a generation unit configured to generate a composite image obtained by superposing the name of the specified candidate of the product name on the image of the product to be purchased.

In another example aspect of the present disclosure, a product recognition system includes: a product recognition server; and a terminal apparatus. The product recognition server includes: an acquisition unit configured to acquire an image of a product to be purchased; a calculation unit configured to calculate a degree of similarity between the image of the product to be purchased and an image of a product stored in association with a product name in advance; a specifying unit configured to specify a candidate of the product name corresponding to the product to be purchased based on the calculated degree of similarity; and a generation unit configured to generate a composite image obtained by superposing the name of the specified candidate of the product name on the image of the product to be purchased.

In another example aspect of the present disclosure, a product recognition method includes: acquiring an image of a product to be purchased; calculating a degree of similarity between the image of the product to be purchased and an image of a product stored in association with a product name in advance; specifying a candidate of the product name corresponding to the product to be purchased based on the calculated degree of similarity; and generating a composite image obtained by superposing the name of the specified candidate of the product name on the image of the product to be purchased.

### BRIEF DESCRIPTION OF DRAWINGS

The above and other aspects, features and advantages of the present disclosure will become more apparent from the following description of certain exemplary example embodiments when taken in conjunction with the accompanying drawings, in which:

FIG. 1 is a configuration diagram of a product recognition apparatus according to a first example embodiment of the present disclosure;

FIG. 2 is a configuration diagram of a product recognition system according to a second example embodiment of the present disclosure;

FIG. 3 is a flowchart of feature point calculation according to the second example embodiment of the present disclosure;

FIG. 4 is a flowchart of candidate product display processing according to the second example embodiment of the present disclosure;

FIG. 5 is a flowchart of product correction processing according to the second example embodiment of the present disclosure;

FIG. 6 shows an example of a database and a product master according to the second example embodiment of the present disclosure; and

FIG. 7 shows an example of a product candidate display screen according to the second example embodiment of the present disclosure.

### EXAMPLE EMBODIMENTS

Example embodiments will be described below with reference to the drawings. Since the drawings are simple, the technical range of the example embodiments should not be interpreted narrowly on the basis of the description of the drawings. The same elements are denoted by the same reference signs, and repeated descriptions are omitted.

The disclosure will be described by dividing it into a plurality of sections or example embodiments whenever circumstances require it for convenience in the following embodiments. However, unless otherwise particularly specified, these sections or embodiments are not irrelevant to one another. One section or example embodiment is related to modified example, applications, details, supplementary explanations, and the like of some or all of the other ones. When reference is made to the number of elements or the like including the number of pieces, numerical values, quantity, range, etc. in the following embodiments, the number thereof is not limited to a specific number and may be greater than or less than or equal to the specific number unless otherwise particularly specified and definitely limited to the specific number in principle.

Further, in the following example embodiments, components (including operation steps, etc.) are not always essential unless otherwise particularly specified and considered to be definitely essential in principle. Similarly, when reference is made to the shapes, positional relations, or the like of the components or the like in the following example embodiments, they will include ones, for example, substantially approximate or similar in their shapes or the like unless otherwise particularly specified and considered not to be definitely so in principle. This is similarly applied even to the above-described number or the like (including the number of pieces, numerical values, quantity, range, etc.).

### First Example Embodiment

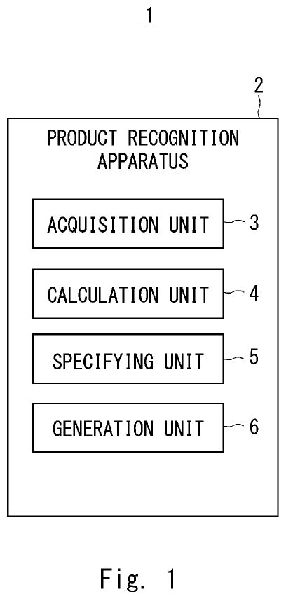

This example embodiment will be described with reference to FIG. 1. FIG. 1 is a configuration diagram of a product recognition apparatus 2 according to this example embodiment.

The product recognition apparatus 2 according to this example embodiment includes an acquisition unit 3, a calculation unit 4, a specifying unit 5, and a generation unit 6.

The acquisition unit 3 acquires an image of a product to be purchased. The product to be purchased includes, for example, a product which a customer intends to purchase or a product which the customer intends to order in a restaurant, etc., but is not limited to them.

The calculation unit 4 calculates a degree of similarity between an image of the product to be purchased and images of products stored in association with a product name in advance. The calculation unit 4 may generate a candidate list of product names corresponding to the acquired image of the product based on the calculated degree of similarity. The candidate list is a list of the recognized product candidates. In the candidate list, the product names may be listed in descending order of the degree of similarity, but the order of the listing is not limited to this.

The specifying unit 5 specifies the candidates of the product names corresponding to the product to be purchased based on the degree of similarity calculated by the calculation unit 4. The generation unit 6 generates a composite image obtained by superimposing the candidates of the product names specified by the specifying unit 5 on the image of the product acquired by the acquisition unit 3.

According to this example embodiment, it is possible to provide the product recognition apparatus 2 which displays the candidates of the product names for each captured image of each product in a manner which is compact and also allows the candidates to be recognized at a glance.

### Second Example Embodiment

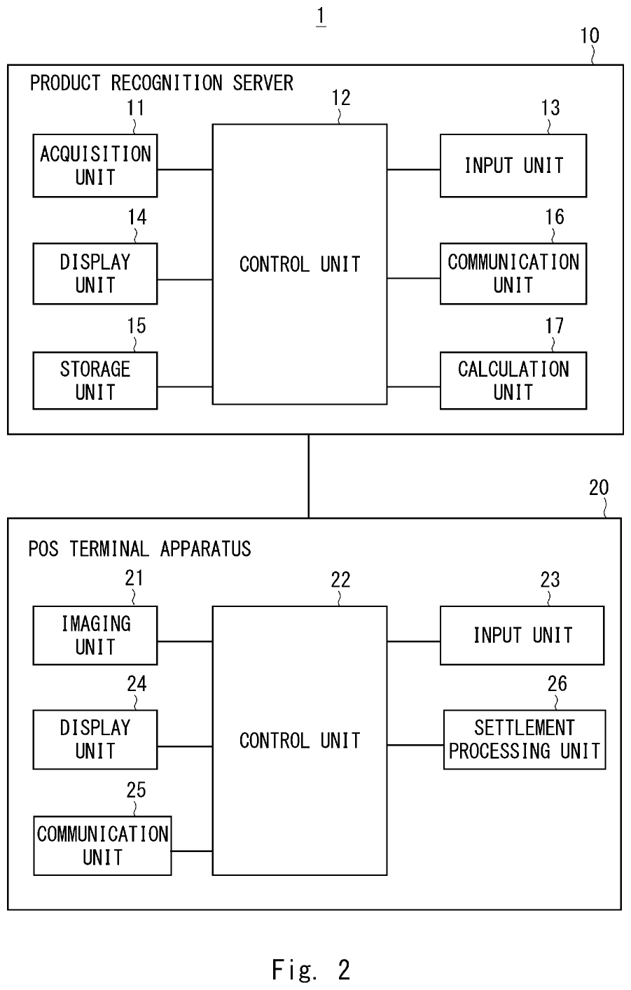

This example embodiment will be described with reference to FIG. 2. FIG. 2 is a configuration diagram of a product recognition system 1 according to this example embodiment.

The product recognition system 1 according to this example embodiment is configured as a POS system used in, for example, a restaurant or a supermarket, but it is not limited to this, and a server and a terminal apparatus capable of communication may be used. In this example embodiment, the product recognition system 1 includes a product recognition server 10 and a POS terminal apparatus 20. The product recognition server 10 and the POS terminal apparatus 20 can communicate with each other.

A configuration of the product recognition server 10 will be described with reference to FIG. 2. FIG. 2 is a configuration diagram of the product recognition system 1. The product recognition system 1 includes the product recognition server 10 and the POS terminal apparatus 20. A plurality of the POS terminal apparatuses 20 may be provided. The product recognition server 10 includes an acquisition unit 11, a control unit 12, an input unit 13, a display unit 14, a storage unit 15, a communication unit 16, and a calculation unit 17. The input unit 13 and the display unit 14 may be configured as a display with a touch panel or may be provided separately from each other. As will be described later, the product recognition server 10 captures an image of a product, calculates feature points of the captured image of the product, and creates a candidate list of the product. The product recognition server 10 may further include a function for managing various sales information, such as management of an operation status of the POS terminal apparatus 20.

The acquisition unit 11 acquires an image of a product which a customer intends to purchase, which is captured by the POS terminal apparatus 20. An object to be acquired by the acquisition unit 11 is an image of a product itself, and instead product identification information such as a barcode or a QR code (registered trademark) of the product may be further read from the product image. Further, the acquisition unit 11 may acquire, from the POS terminal apparatus 20, the product identification information such as the product barcode read by the POS terminal apparatus 20. The acquisition unit 11 may include a camera for capturing an image of the product and may be configured to capture an image of the product.

The control unit 12 controls an operation of each unit of the product recognition server 10. The control unit 12 has a function of executing various kinds of control in accordance with various kinds of programs stored in storage means, and is implemented by a Central Processing Unit (CPU), a Read Only Memory (ROM), a Random Access Memory (RAM), an input/output port (I/O), etc.

The input unit 13 receives an operation instruction from a user. The input unit 13 may be composed of a keyboard or a touch panel display apparatus. A keyboard or a touch panel connected to a main body of the product recognition server 10 may be used. The operation instruction received by the input unit 13 may be received from the input unit 23 of the POS terminal apparatus.

The display unit 14 displays the image of the product acquired by the acquisition unit 11. The display unit 14 displays the candidates of the product names based on the feature points of the product calculated in feature point calculation processing by the calculation unit 17, which will be described later in detail. The display unit 14 is composed of various display means such as a Liquid Crystal Display (LCD) and a Light Emitting Diode (LED). The contents displayed by the display unit 14 may be displayed on a display unit 24 of the POS terminal apparatus 20. The contents displayed on the display unit 14 may be displayed on a device such as a mobile phone including a so-called smartphone owned by the user.

The storage unit 15 stores the image of the product captured beforehand for each kind of product for each of a plurality of the products. The storage unit 15 stores product master information including a product identification code for identifying a product and information about a product name. As the product identification code, for example, a code for identifying a product such as a Price Look Up (PLU) code or a Japanese Article Number (JAN) code can be used. Further, after performing the feature point calculation processing described later, the storage unit 15 stores, in a database, the feature points of the product and the product identification information such as the product identification code in association with each other.

The storage unit 15 may include a non-volatile memory (e.g., Read Only Memory (ROM)) in which various programs and various data necessary for processing are fixedly stored. The storage unit 15 may be an HDD or SSD. Further, the storage unit 15 can include a volatile memory such as a Random Access Memory (RAM) used as a work area. The program may be read from a portable recording medium such as an optical disk or a semiconductor memory, or may be downloaded from a server apparatus on a network.

The communication unit 16 communicates with the POS terminal apparatus 20. The communication unit 16 may include an antenna (not shown) for performing radio communication with the POS terminal apparatus 20, or may include an interface such as a Network Interface Card (NIC) for performing wired communication.

The calculation unit 17 identifies the product based on the image of the product acquired by the acquisition unit 11. The calculation unit 17 performs processing for calculating the feature points of the product and displaying the candidate product, which will be described in detail later.

The POS terminal apparatus 20 includes an imaging unit 21, a control unit 22, an input unit 23, the display unit 24, a communication unit 25, and a settlement processing unit 26. The input unit 23 and the display unit 24 may have one configuration as a display with a touch panel or may be provided separately from each other. The POS terminal apparatus 20 is, for example, a dedicated computer installed at a cash register. As will be described later, the POS terminal apparatus 20 captures an image of the product, instructs the calculation of the feature point of the captured image of the product, displays the candidate list of the products, and performs settlement processing.

Since the control unit 22, the input unit 23, and the display unit 24 have the same functions as those of the control unit 12, the input unit 13, and the display unit 14 of the product recognition server 10, respectively, the description thereof will be omitted.

The imaging unit 21 reads the product which the customer intends to purchase. Although the object to be read by the imaging unit is the product itself, the imaging unit 21 may further include a function of reading a barcode or a QR code (registered trademark) of the product that enables recognition of the information about the product. The imaging unit 21 may include a camera for photographing the product. The image of the product read by the imaging unit 21 is transmitted to the product recognition server 10.

The communication unit 25 communicates with the product recognition server 10. The communication unit 25 may include an antenna (not shown) for performing wireless communication with the product recognition server 10, or may include an interface such as a Network Interface Card (NIC) for performing wired communication.

The settlement processing unit 26 calculates the total price of products to be purchased by the customer and performs the settlement processing. The settlement processing unit 26 may have a function of processing the sales and the contents of the sales.

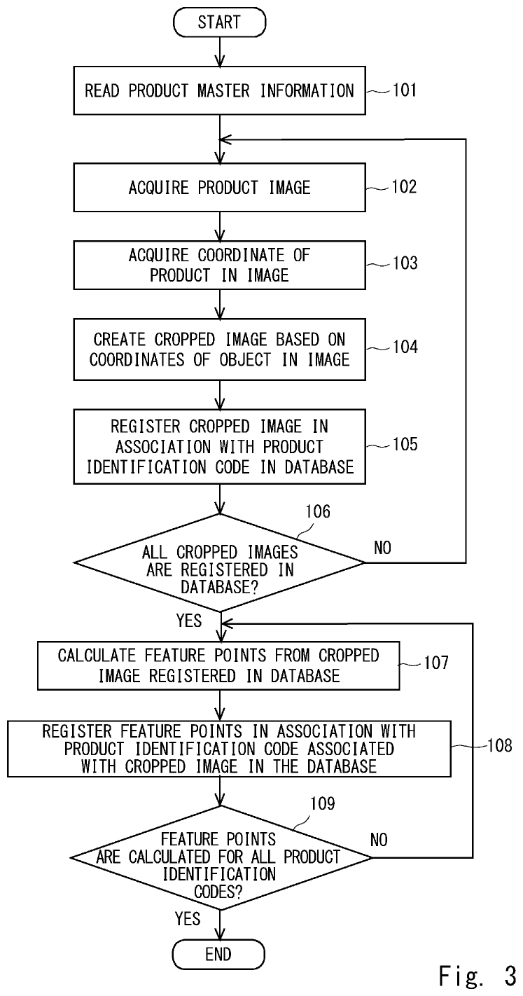

The feature point calculation processing performed by the calculation unit 17 of the product recognition server 10 will be described with reference to FIG. 3. The feature point calculation processing is processing for storing, in the storage unit 15, the product identification information such as the product identification code in association with the feature points for all the products that may be identified by image recognition. FIG. 3 is a flowchart of feature point calculation performed by the calculation unit 17.

In the feature point calculation processing, the calculation unit 17 calculates the feature points of the image detected as an object from the captured image of the product. The product recognition server 10 reads the product master information (Step 101).

The acquisition unit 11 of the product recognition server 10 acquires the image of one product captured by the imaging unit 21 of the POS terminal apparatus 20 (Step 102). The calculation unit 17 acquires coordinate information of the product included in the acquired image of the product (Step 103). The calculation unit 17 creates a cropped image obtained by cropping an image of a product part from the acquired image based on the acquired coordinate information (Step 104). The product recognition server 10 registers the created cropped image in the database in association with the product identification code included in the product master information included in the storage unit 15 (Step 105). If all the cropped images are not registered in the database (NO in Step 106), the product recognition server 10 repeats acquisition of the product image (Step 102). That is, the user acquires an image by capturing an image of each of the remaining products, creates a cropped image for each of the images, and inputs the corresponding product identification code.

When all the cropped images are registered in the database (YES in Step 106), the product recognition server 10 calculates the feature points from the cropped image registered in the database for each of the plurality of acquired products (Step 107). The storage unit 15 registers, in the database, the calculated feature points in association with the product identification code associated with the cropped image used for the calculation of the feature points (Step 108). When the feature points are calculated for all the product identification codes, the product recognition server 10 ends the processing (YES in Step 109). When the feature points are not calculated for all the product identification codes (NO in Step 109), the feature points are further calculated from the cropped image registered in the database (Step 107). In this way, the product identification code and the feature points of each of the plurality of products are stored in the storage unit 15 in association with each other.

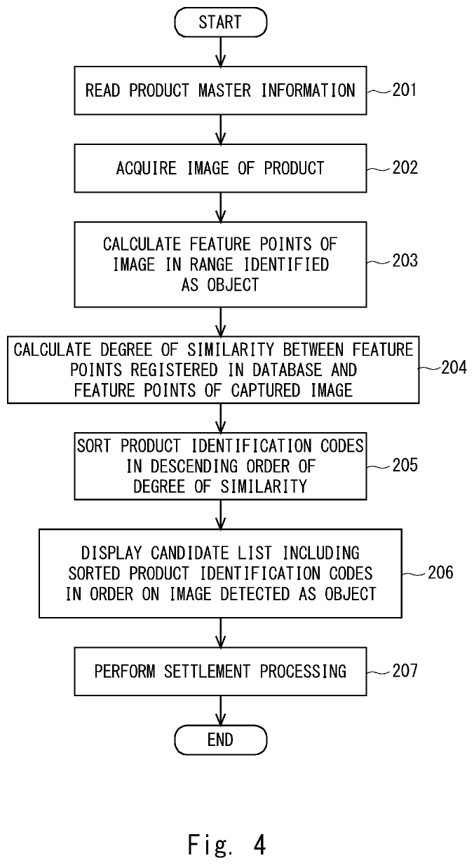

Next, candidate product display processing will be described with reference to FIG. 4. FIG. 4 is a flowchart of the candidate product display processing performed by the product recognition server 10. In the candidate product display processing, the display unit 14 displays the candidate product based on the feature points calculated by the calculation unit 17 in the feature point calculation processing.

The product recognition server 10 reads the product master information (Step 201). The acquisition unit 11 of the product recognition server 10 acquires the image of the product to be purchased from the POS terminal apparatus 20 (Step 202). The calculation unit 17 calculates the feature points of the image in a range identified as an image of the product itself in the acquired images of the product (Step 203). The calculation unit 17 calculates the degree of similarity by comparing the feature points registered in the database with the feature points of the captured image (Step 204). This degree of similarity calculation processing is performed for all or some of the plurality of products stored in the storage unit 15. The degree of similarity is an indicator of how similar the products are, and can be referred to as a score.

The calculation unit 17 sorts the product identification codes in descending order of the calculated degree of similarity (Step 205). The calculation unit 17 may enumerate the candidate list of the sorted product identification codes in order and display the candidate list on the display unit 14 by superimposing it on the image of the product (Step 206). After the above processing, the settlement processing unit 26 of the POS terminal apparatus 20 performs the settlement processing (Step 207).

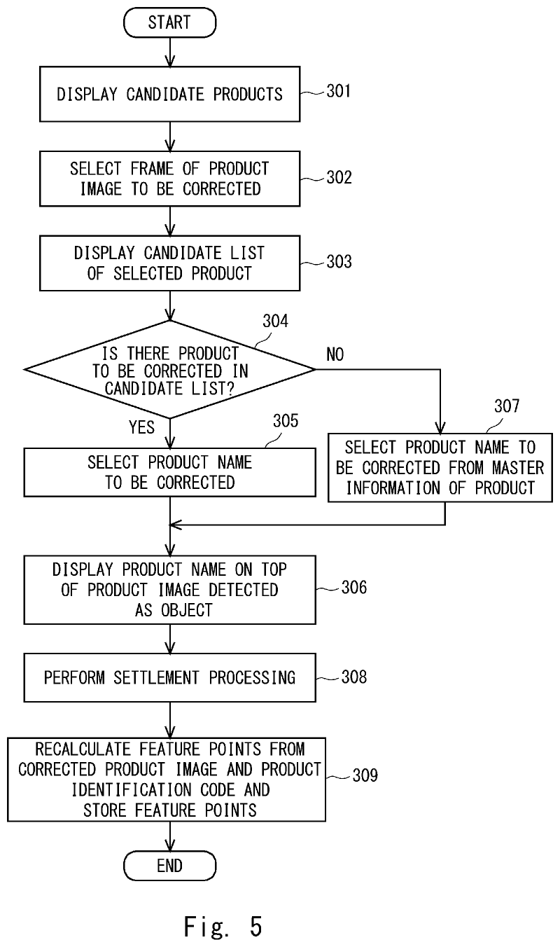

Product correction processing performed by the POS terminal apparatus 20 will be described with reference to FIG. 5. FIG. 5 is a flowchart of the product correction processing performed by the POS terminal apparatus 20. The product correction processing is performed by selecting a product name from the candidate list displayed as a candidate in the candidate product display processing. The selection of the product from the candidate list may be performed from the candidate list superimposed on the image of the product. The product correction processing described below is performed by the POS terminal apparatus 20, and instead may be performed by the product recognition server 10.

The display unit 24 of the POS terminal apparatus 20 displays the candidate list of products (Step 301). An example of a product candidate display screen will be described later with reference to drawings. The user may select a frame of the image of the product to be corrected from among the plurality of displayed products (Step 302). The product may be selected by a touch panel operation on the input unit 23 or the display unit 24 or by a keyboard operation. The display unit 24 displays the candidate list of the selected product (Step 303).

When there is a product to be corrected in the candidate list (YES in Step 304), the user selects the product name to be corrected from the candidate list (Step 305), and the display unit 24 displays the product name superimposed on the image of the product detected as an object (Step 306).

When there is no product to be corrected in the candidate list (NO in Step 304), the user selects the product name to be corrected from the master information of the product (Step 307), and the display unit 24 displays the selected product name by superimposing the selected product name on the image of the product (Step 306).

After the above processing, the settlement processing unit 26 performs the settlement processing (Step 308). The storage unit 15 of the product recognition server 10 may recalculate the feature points from the corrected product image and the product identification code and then store the recalculated feature points (Step 309).

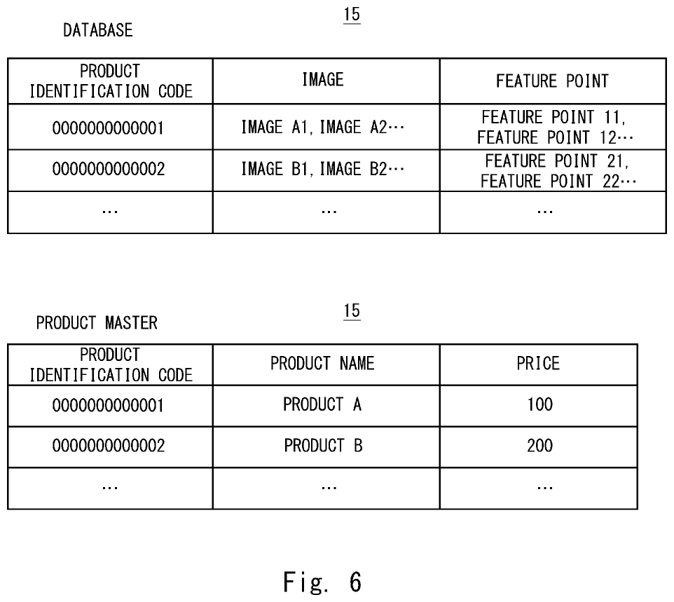

FIG. 6 shows an example of the database and the product master stored in the storage unit 15 according to this example embodiment. Items of the product identification code, the image, and the feature points are provided in the database. In the database, the feature points calculated by the calculation unit 17 as described above are registered in association with the product identification code, which is associated with the cropped image used for calculating the feature points. The “image” indicates the image of the product. The product master has the items of the product identification code, the product name, and a price, and these items are registered in association with each other. The items in the database and the product master are not limited to the example shown in FIG. 6.

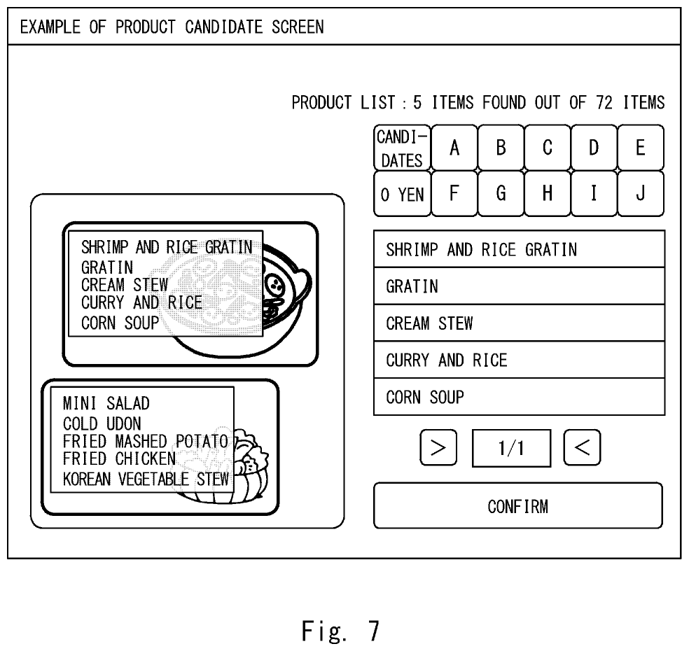

An example of the displayed product candidate display screen is shown in FIG. 7. In the example of FIG. 7, the captured image of the product is displayed on the left side. As in the example of FIG. 7, several products may be displayed and a product to be corrected may be selected. Here, “shrimp and rice gratin” is selected. In the example of FIG. 7, the candidate list of the selected product is displayed on the right side. The selection of the product from the candidate list may be performed from the candidate list superimposed on the image of the product. When the user wants to select a product that is not on the candidate list, the user may select a filter button on the upper right of the screen to display the product registered in the product master. The product can be corrected by selecting and determining any product from the displayed product candidates. The product candidate display screen is not limited to the example of FIG. 7.

As described above, when the product recognition result is displayed on the screen, all the candidates of the plurality of products can be confirmed by displaying the candidates, which can be displayed on the screen, in the frame on the image of the product. By doing so, it is possible to confirm all the candidates of the plurality of products collectively, and there are few procedures for selecting the products. The products can be distinguished from each other without using codes such as barcodes for distinguishing the products.

According to this example embodiment, it is possible to provide the product recognition system 1 which displays the candidates of the product names for each captured image of each product in a manner which is compact and also allows the candidates to be recognized at a glance.

### Other Example Embodiment

The product recognition apparatus 2 according to the present disclosure includes, for example, an example embodiment as a product recognition method. Specifically, the product recognition method includes acquiring an image of a product to be purchased, calculating a degree of similarity between the image of the product to be purchased and an image of a product stored in association with a product name in advance, specifying a candidate of the product name corresponding to the product to be purchased based on the calculated degree of similarity, and generating a composite image obtained by superposing the name of the specified candidate of the product name on the image of the product to be purchased.

In the above example, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories. Examples of the semiconductor memories are mask ROM, PROM (Programmable ROM), EPROM (Erasable PROM), flash ROM, and RAM (Random Access Memory), etc. The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The above program causes a computer to execute a process of acquiring an image of a product to be purchased, a process of calculating a degree of similarity between the image of the product to be purchased and an image of a product stored in association with a product name in advance, a process of specifying a candidate of the product name corresponding to the product to be purchased based on the calculated degree of similarity, and a process of generating a composite image obtained by superposing the name of the specified candidate of the product name on the image of the product to be purchased.

According to the present disclosure, it is possible to provide a product recognition apparatus, a product recognition system, and a product recognition method which make it clear at a glance what kind of product names are candidates for respective captured images of products.

Note that the present disclosure is not limited to the above-described example embodiments, and may be modified as appropriate without departing from the purpose.

While the disclosure has been particularly shown and described with reference to example embodiments thereof, the disclosure is not limited to these example embodiments. It will be understood by those of ordinary skill in the art that various changes in form and details may be made therein without departing from the spirit and scope of the present disclosure as defined by the claims.

What is claimed is:

1. A product recognition apparatus comprising:
an acquisition unit configured to acquire an image of a product to be purchased;
a calculation unit configured to calculate a degree of similarity between the image of the product to be purchased and an image of a product stored in association with a product name in advance;
a specifying unit configured to specify a candidate of the product name corresponding to the product to be purchased based on the calculated degree of similarity; and
a generation unit configured to generate a composite image obtained by superposing the name of the specified candidate of the product name on the image of the product to be purchased.

2. The product recognition apparatus according to claim 1, wherein
the calculation unit is configured to generate a candidate list of the product names corresponding to the acquired image of the product based on the degree of similarity, and
the generation unit is configured to generate a composite image obtained by superposing the product names of a plurality of products included in the candidate list on the image of the product to be purchased.

3. The product recognition apparatus according to claim 2, wherein
the generation unit is configured to list the product names of the plurality of products included in the candidate list in descending order of the degree of similarity and generate the composite image obtained by superimposing the listed product names on the image of the product to be purchased.

4. The product recognition apparatus according to claim 2, wherein
the product recognition apparatus is configured to perform processing of selecting the product name corresponding to the acquired image of the product from the candidate list.

5. A product recognition system comprising:
a product recognition server; and
a Point Of Sales (POS) terminal apparatus, wherein
the product recognition server comprises:
an acquisition unit configured to acquire an image of a product to be purchased from the POS terminal apparatus;
a calculation unit configured to calculate a degree of similarity between the image of the product to be purchased and an image of a product stored in association with a product name in advance;
a specifying unit configured to specify a candidate of the product name corresponding to the product to be purchased based on the calculated degree of similarity; and
a generation unit configured to generate a composite image obtained by superposing the name of the specified candidate of the product name on the image of the product to be purchased.

6. The product recognition system according to claim 5, wherein
the calculation unit is configured to generate a candidate list of the product names corresponding to the acquired image of the product based on the degree of similarity, and
the generation unit is configured to generate a composite image obtained by superposing the product names of a plurality of products included in the candidate list on the image of the product to be purchased.

7. The product recognition system according to claim 6, wherein
the generation unit is configured to list the product names of the plurality of products included in the candidate list in descending order of the degree of similarity and generate the composite image obtained by superimposing the listed product names on the image of the product to be purchased.

8. The product recognition system according to claim 6, wherein
the product recognition apparatus is configured to perform processing of selecting the product name corresponding to the acquired image of the product from the candidate list.

9. A product recognition method comprising:
acquiring an image of a product to be purchased;
calculating a degree of similarity between the image of the product to be purchased and an image of a product stored in association with a product name in advance;
specifying a candidate of the product name corresponding to the product to be purchased based on the calculated degree of similarity; and
generating a composite image obtained by superposing the name of the specified candidate of the product name on the image of the product to be purchased.
